(19) United States
(12) Patent Application Publication
(10) Pub. No.: US 2024/0119198 A1
(43) Pub. Date: Apr. 11, 2024

(54) COMMUNICATION REDUCTION TECHNIQUES FOR PARALLEL COMPUTING

(71) Applicant: Advanced Micro Devices, Inc., Santa Clara, CA (US)

(72) Inventors: Laurent S. White, Austin, TX (US); Johnathan Alsop, Bellevue, WA (US); Ganesh Dasika, Austin, TX (US)

(21) Appl. No.: 17/958,058

(22) Filed: Sep. 30, 2022

(51) Int. Cl. G06F 30/23; G06F 30/27

(52) U.S. Cl. CPC G06F 30/23; G06F 30/27; G06F 2119/02

(57) ABSTRACT

A physical system is simulated using a model including a plurality of elements in a mesh or grid. The elements are divided into partitions processed by different processing units. For some time steps, state data is transmitted between partitions and used to calculate flux data for updating the state of edge elements of the partitions. Periodically, transmission of state data is suppressed, and flux data is obtained by linear interpolation based on past flux data. Alternatively, flux data is obtained by processing state variables of an edge element and past flux data using a machine learning model, such as a DNN. Whether to suppress transmission of state data may be determined based on one or both of (a) uncertainty in an output of the machine learning model (e.g., Bayesian neural network) and (b) complexity of model of the physical system (e.g., spatial or temporal gradients).

### RELATED APPLICATION

This application is related to U.S. application Ser. No. 17/561,227 filed Dec. 23, 2021, and entitled METHODS OF COMMUNICATION AVOIDANCE IN PARALLEL SOLUTIONS OF PARTIAL DIFFERENTIAL EQUATIONS, which is hereby incorporated herein by reference in its entirety for all purposes.

### BACKGROUND

Many scientific problems may be modeled by partial differential equations. Electromagnetic fields may be approximated using the Maxwell's equations. Propagation of acoustic waves may be modeled using the acoustic wave equation. Fluid dynamics may be modeled using the Navier-Stokes equation. All of these equations include partial derivatives of multiple variables. Nearly every field of science and technology relies on some form of partial differential equations to model physical systems.

Inasmuch as closed form solutions to these equations do not exist for a typical physical system, they are modeled by discretizing the physical system into a grid or mesh of elements that each have one or more variables describing the state of each element. At each time step, the state of an element is updated based on its current state and the state of adjacent elements at the previous time step. For purpose of this application, the contribution of each neighboring element to the state of the element is referred to as “flux.” The flux for a given physical system may represent the transmission of pressure, electromagnetic fields, force, momentum, or some other modeled phenomenon.

Referring to FIG. 1, a physical system may be modeled by many thousands, millions, or more elements, represented by the depicted triangles. Such models cannot possibly be stored in the memory of a single computer and updating each element at each time step cannot be performed in a timely manner by a single processor. Accordingly, the model may be divided into partitions, P0-P3 in the depicted example. Each partition P0-P3 includes a set of contiguous elements. Each partition P0-P3 may be processed by a separate processing unit. The processing units may include processing cores of a multi-core processor or graphics processing unit (GPU). The processing units may be distributed across multiple computing devices coupled to one another by a backplane of a common chassis or a network.

The state S1 of an element of partition P2 cannot be updated until the flux data F has been calculated from state S2 received from the neighboring element of partition P3. The flux data F is computed based on the state S2 of the neighboring element, which is not stored in the memory of the same processing unit that stores state S1. The process of preparing and transmitting the state between processing units adds significant delay to updating the elements of the model at each time step.

Referring to FIG. 2A, the state is packed 200 by the processing unit hosting partition P3 and transfer to the processing unit hosting partition P2 is initiated. Packing may include compressing and/or packaging the state into a message passing interface (MPI) message. The state from some or all elements of partition P3 on the boundary between partitions P2 and P3 may be included in the message. The message is then transferred 202. The processing unit hosting partition P2 receives and unpacks 204 the message to obtain the states of the elements on the boundary between partitions P2 and P3. The processing unit hosting partition P2 then performs 206 local calculations, i.e., updating the state of elements that are not adjacent to the elements of another partition. This may include calculating flux between neighboring elements within the partition P2. The processing unit hosting partition P2 may also perform 208 edge calculations whereby the states of edge elements in P2 neighboring other partitions are updated using the flux calculated from the states received in messages from the neighboring partition. In the depicted example, this includes updating state S1 using the flux data F calculated from state S2 received for partition P3.

Referring to FIG. 2B, some improvement is obtained by performing 206 the local calculations during transfer 202 of the message inasmuch as these calculations do not rely on states from neighboring partitions. As is represented in FIG. 2B, the time required to perform 206 the local calculations is typically much less than the time required to transfer 202 and unpack 204 the message. This limits the amount of time that can be saved using this approach. Since the time spent performing local calculations is small relative to the time spent transferring 202 states, there is often little benefit to improving the performance of a kernel defining the calculations.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a schematic representation of a mesh divided into partitions for processing by separate processing units;

FIG. 2A is a timing diagram depicting the processing of elements and transmission of state data;

FIG. 2B is a timing diagram depicting an alternative approach for processing elements and transmitting state data;

FIG. 3 is a process flow diagram of a method for reducing transmission of state data in accordance with an implementation.

FIG. 4A is a plot of flux values for an element over time;

FIG. 4B is a plot depicting variation in a flux value within a given element over time with and without extrapolation in accordance with an implementation.

FIG. 5 is a schematic block diagram of a machine learning approach for predicting flux data in accordance with an implementation;

FIG. 6A is a timing diagram depicting the processing of elements and transmission of state data for multiple time steps in accordance with the prior art;

FIG. 6B is a timing diagram depicting the processing of elements with periodic suppression of transmission of state data in accordance with an implementation;

FIG. 7 is a parity plot of actual flux values with respect to flux values predicted in accordance with an implementation;

FIG. 8A is a surface plot of a state variable of elements of a model obtained using communication of state data at every time step;

FIG. 8B is a surface plot of a state variable of elements of a model obtained with suppression of communication of state data at every other time step in accordance with an implementation;

FIG. 9A is a surface plot of a state variable of a model having parameters identical to those used to train a machine learning model used to estimate flux values;

FIG. 9B is a surface plot of a state variable of a model having parameters different from those used to train the machine learning model used to estimate flux values;

FIG. 10 is a schematic block diagram of a system for determining the appropriateness of suppressing communication;

FIG. 11 is a process flow diagram of a method for determining the appropriateness of suppressing communication;

FIG. 12 is a process flow diagram of a method for determining the appropriateness of suppressing communication based on model complexity;

FIG. 13 is a plot of solutions to a physical model;

FIG. 14 is a process flow diagram of a method for determining the appropriateness of suppressing communication based on both uncertainty and model complexity;

FIG. 15 is a timing diagram depicting the timing of evaluation of the appropriateness of suppressing communication; and

FIG. 16 is a schematic block diagram of a computing device that may be used to implement the system and methods described herein.

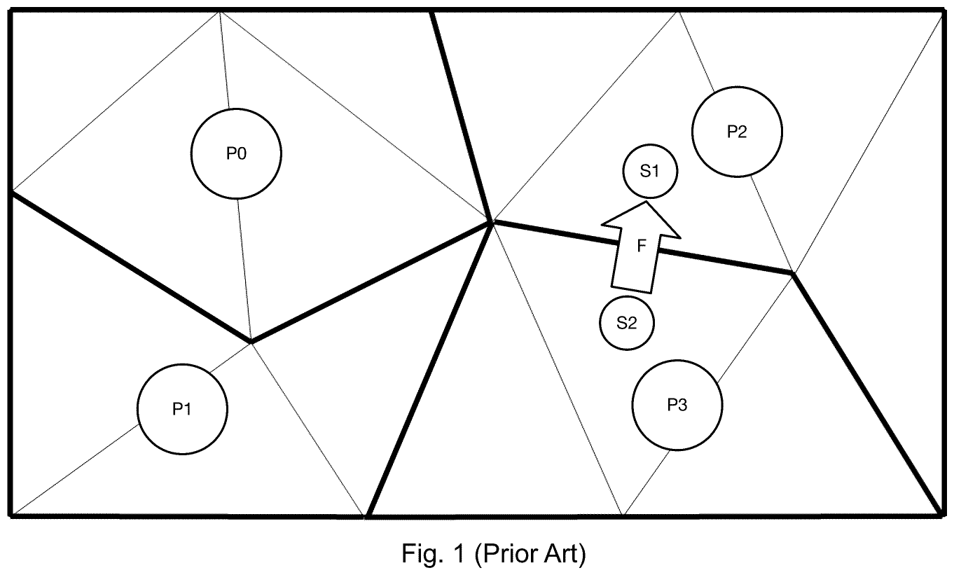

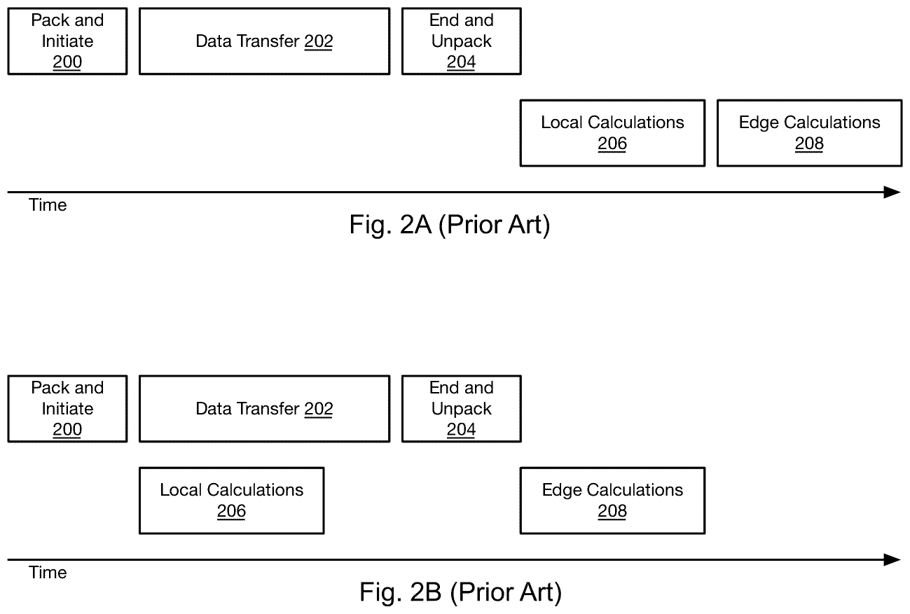

### DETAILED DESCRIPTION

In the following description, for the purposes of explanation, numerous specific details are set forth in order to provide a thorough understanding. It will be apparent, however, that implementations may be practiced without these specific details. In other instances, well-known structures and devices are shown in block diagram form.

### General Overview

A physical system is modeled by a mesh or grid of elements that are divided into partitions. Each partition is processed by a different processing unit. The state of the system over time is modeled by updating each element at each time step of a plurality of discrete time steps. Each element is updated based on the current state of the element and flux data that is calculated based on state data received from neighboring elements. Periodically, transmission of state data between processing units hosting neighboring partitions is suppressed. Flux data for neighboring partitions is estimated by extrapolating from past flux values, such as flux values from two or more preceding time steps. In an alternative approach, flux data is estimated using a machine learning model trained to estimate flux data for the physical system. In this manner, processing times are reduced by at least partially eliminating data transmission between processing units. Whether or not to suppress transmission of state data may be determined based on one or both of uncertainty in an estimated flux value calculated using the machine learning model and gradients of variables defining the state of each element.

### Estimating Flux Data Using Extrapolation

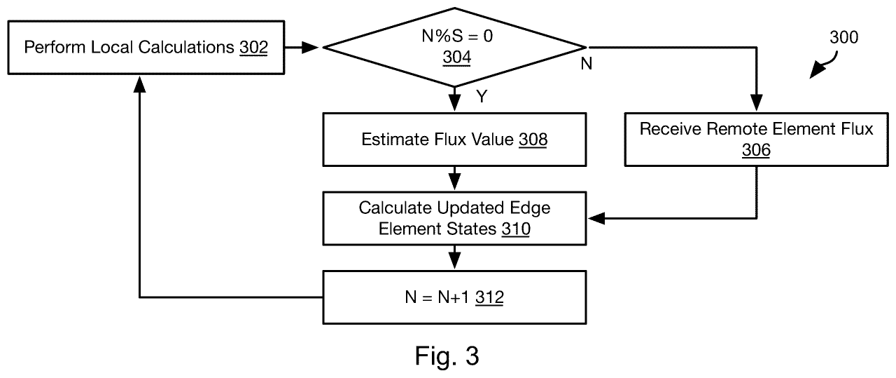

FIG. 3 depicts a method 300 that is used to extrapolate flux data. The method 300 is performed by a processing unit (“the local processing unit”) hosting a partition (“the local partition”) with communication with another processing unit (“the remote processing unit”) hosting another partition (“the remote partition”). The method 300 is performed by the local processing unit with respect to any number of remote processing units and remote partitions. The method 300 is capable of being used for a two-dimensional system, three-dimensional system, or systems modeled using a greater number of dimensions.

For some physical systems, the method 300 is preceded by initializing state variables of elements of the model for all partitions. In particular, the state variables of one or more elements may be set to initial conditions of the physical system being modeled. The state variables of elements of the boundary of the model of the physical system are also set to boundary conditions where this is part of the physical system being modeled.

State variables are referred to in the plural in the examples discussed herein. However, a single state variable is usable without modifying the approach described herein. In some implementations, the state of an element is represented by values for the state variables as well as one or more partial derivatives of one or more of the state variables. Partial derivatives include first order and/or higher order derivatives.

The method 300 includes at step 302 performing local calculations. Performing local calculations includes calculating flux between non-edge elements of the local partition and updating the state variables of the non-edge elements using the flux and current values of the state variables. The manner in which the flux is calculated and the state variables are updated is according to the physical system being modeled and is performed using any modeling approach known in the art.

The method 300 includes in step evaluating 304 whether the index (N) of the current time step corresponds to a time step in which communication of state data between the local processing unit and the remote processing unit is to be suppressed. For example, in some implementations, one time step out of every S time steps is suppressed, where S is an integer greater than one. For example, S=3 results in communication being suppressed every third time step. In some implementations, the evaluation 304 includes evaluating whether N % S is equal to zero, where % is the modulus operator. Other values of S may be used, such as 2, in order to suppress transmission on every other time step. Other more complex repeating patterns may be used to determine whether transmission is to be suppressed. For example, a repeating pattern may be defined as transmit for Q steps and suppress for R steps, where one or both of Q and R are greater than one. In some implementations, suppression of transmission does not begin until N is greater than a threshold value that is greater than S.

If communication is not suppressed, the method 300 includes in step receiving 306 remote state data from the remote processing unit, the state data including states corresponding to each of the edge elements of the remote partition adjoining the edge elements of the local partition. In some implementations, the remote state data may be received in the form of a MPI message and used to calculate flux values. If communication is suppressed, the method 300 includes in step 308 estimating flux values for each edge element without the use of remote state data. In a first example discussed herein, estimating flux values includes performing extrapolation based on past flux values. For example, where F(N−2) and F(N−1) are the flux values for a particular edge element of the local partition from the time steps preceding the current time step N, F(N) for the edge element may be calculated as a linear extrapolation of F(N−2) and F(N−1). For example, the point (N, F(N)) is calculated such that it lies on a line passing through points (N−2, F(N−2)) and (N−1, F(N−1)). In some implementations, more points are used. For example, where three points are used, a quadratic extrapolation may be performed. The linear extrapolation results in a 33 percent reduction in data transmission requirements.

For either outcome of the evaluation 304, updated states of the edge elements of the local partition are calculated in step 310 using either the flux data calculated from remote state data from step 306 or the extrapolated flux data from step 308 and current values of the state variables of the edge elements. The time step index is then incremented 312 and the method 300 repeats at step 302.

### Experimental Results

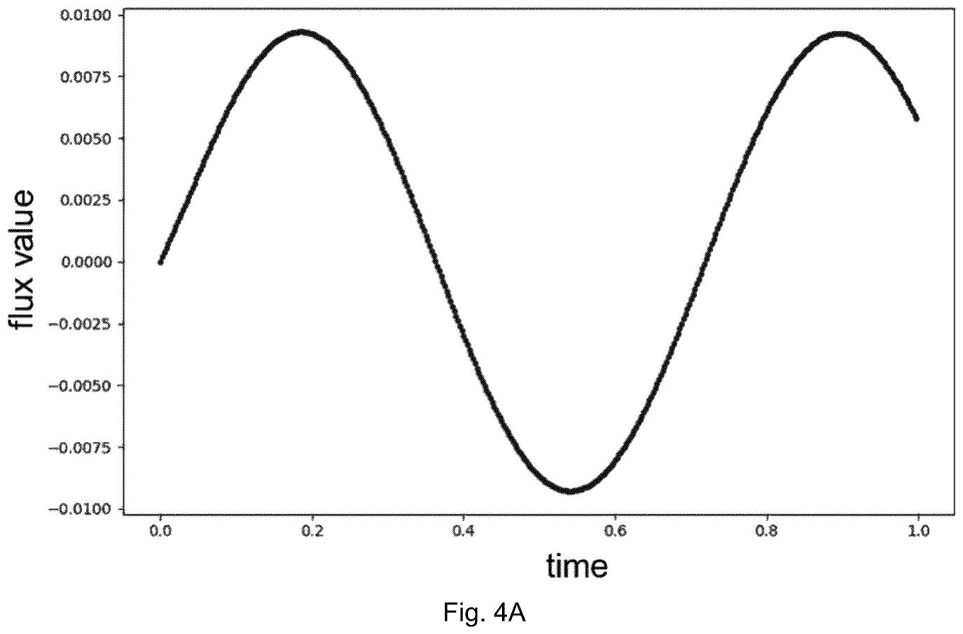

FIG. 4A is a plot of actual values of flux into an element in a model of a physical system modeling acoustic wave propagation. FIG. 4B is a plot of actual transmitted flux (without extrapolation) as compared to flux including both transmitted (i.e., calculated from transmitted state data) and extrapolated flux. In the depicted plot, extrapolation is performed every third time step. As is apparent, there is a discernible error for some extrapolated values. However, the plot of FIG. 4B shows that the model has numerical stability and the non-extrapolated flux values do not have discernible accumulated error due to errors in preceding extrapolated values.

In the depicted examples, the state data for each element includes values for state variables including p (pressure), u (particle velocity in the x direction), and v (particle velocity in the y direction). Table 1 lists errors in the state variables following 200 time steps for modeling with transmission of state data and modeling with periodic suppression of transmission of state data on every third time step. As is apparent, the accuracy is the same up to the third digit of precision.

TABLE 1
Error Values

| | | Error with Suppression of |
|---|---|---|
| Variable | Error with Transmission | Transmission (1 in 3) |
| p | 1.787874 × 10⁻² | 1.786047 × 10⁻² |
| u | 1.412958 × 10⁻² | 1.414311 × 10⁻² |
| v | 1.412959 × 10⁻² | 1.414312 × 10⁻² |

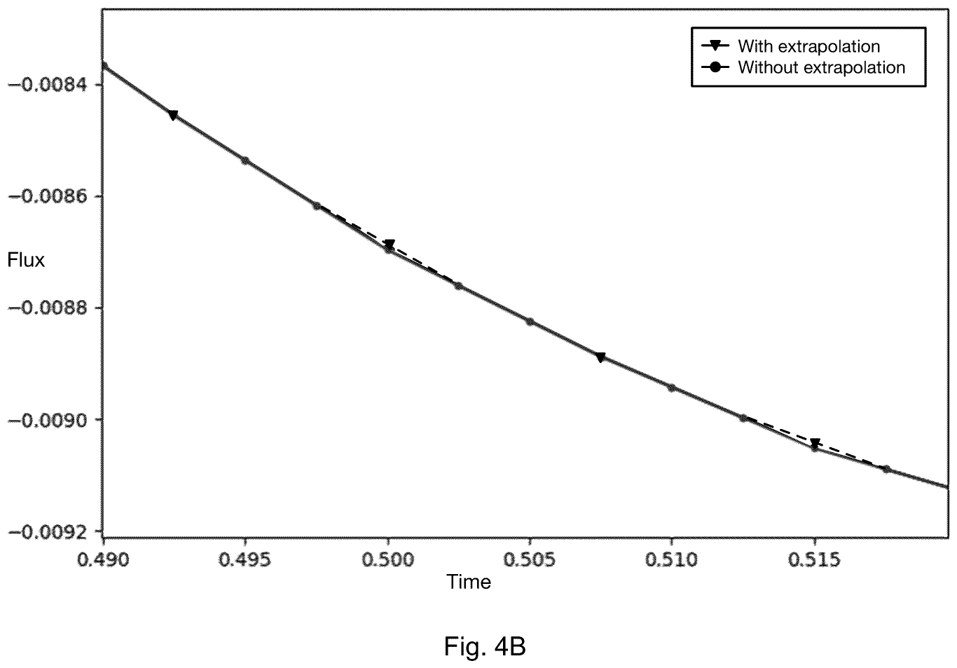

FIG. 5 depicts a system 500 that makes use of machine learning to facilitate suppression of transmission of state data. For example, the system 500 is used at step 308 in some implementations of the method 300 to estimate flux values without transmitted state data. The system 500 includes a machine learning model, which is a deep neural network (DNN) 502 in the depicted example. Other types of neural networks such as recurrent neural networks (RNN) or convolution neural networks (CNN) may also be used. In other implementations, the machine learning model is a genetic algorithm, Bayesian network, decision tree, or other type of machine learning model.

In the depicted implementation, the DNN 502 includes a plurality of layers including an initial layer 504, a final layer 506, and one or more hidden layers 508 between the initial layer and the final layer 506. For the acoustic wave equation, 10 units per layer 504, 506, 608 and three hidden layers 508 were found to be adequate. The activation for each layer 506, 508 may be a rectified linear activation unit (ReLU) function 510. In some implementations, the DNN 502 is preceded by a normalization stage 512 and followed by a denormalization stage 514, which outputs a predicted flux value 516.

Inputs to the DNN 502 include an element state 518 and a prior flux value 520. The element state 518 includes one or more state variables. In some implementations, the element state 518 includes first order, second order, or other derivatives of one or more of the state variables. In some implementations, the element state 518 includes only values that are local to the local processing unit and includes only values that are inputs to the function used to compute the updated state of an element. The state variables and any derivatives thereof will correspond to the physical system being modeled.

For example, with transmission of state data, the flux into an element from a neighboring element is of the form F=f(pⁱⁿ,p^{ex}), where f is a mathematical function according to the physical model, pⁱⁿ is one or more state variables of the element, and p^{ex} is one or more state variables of the neighboring element. Accordingly, the state data transmitted from the remote processing unit to the local processing unit may be the one or more state variables of the neighboring element or some representation thereof, such as a delta with respect to a previous value of the one or more state variables.

With suppression of transmission of state data, the DNN 502 may calculate the flux according to

$$: F = f ( {p}^{i n} , \frac{\partial {p}^{i n}}{d x} , \frac{\partial {p}^{i n}}{d y} , {F}_{prev} ) ,$$

where pⁱⁿ is one or more state variables for the element as calculated in the prior time step,

$$\frac{\partial {p}^{i n}}{dx}$$

is one or more partial derivatives of the one or more state variables with respect to x from the prior time step,

$$\frac{\partial {p}^{i n}}{dy}$$

is one or more partial derivatives of the one or more state variables with respect to y from the prior time step, and Fₚᵣₑᵥ is the flux received from the neighboring element in a prior time step. Using the example of the acoustic wave equation, the element state 518 includes such values as p, ∂p/dx, ∂p/dy, ∂u/dx, ∂u/dy, ∂v/dx, and ∂v/dy. In the three-dimensional case, the element state 518 may include such values as p, ∂p/dx, ∂p/dy, ∂p/dz, ∂u/dx, ∂u/dy, ∂u/dz, ∂v/dx, ∂v/dy, ∂v/dz, ∂w/dx, ∂w/dy, and ∂w/dz, where w is particle velocity in the z direction.

Training of the DNN 502 is performed by generating training data entries. The training data entries are obtained by processing a model of a physical system including a grid or mesh of elements as described above. A training data entry may be generated by using the one or more state variables and flux value of an element prior to a current time step as inputs and the flux value calculated for the current time step as the desired output. Note that training data entries may be generated for any element of the model with respect to any neighboring element and need not correspond to edge elements on a boundary of a partition. Training of the DNN 502 may include using a stochastic process or other techniques to hinder overfitting.

Training using the training data entries is performed according to any approach known in the art for the machine learning model being used for the system 500. For example, for the acoustic wave model in the above-described examples, training data was generated by running a numerical simulation for 100 time steps and generating a training data entry for each element at each time step. 90 percent of the training data entries were used for training and the remainder were used for validation. Training was performed with batch sizes of 256 training data entries for 100 epochs. The reduced batch size was found to help convergence and reduce the variance of predictions. This is just an example of training. Other machine learning models for predicting flux for models of other physical system may use different sizes of batches, different number of epochs.

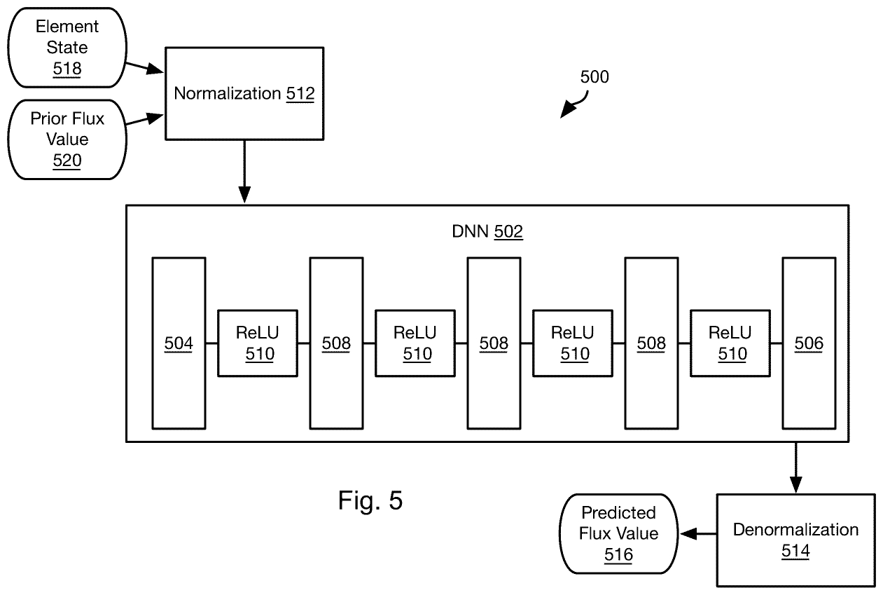

FIGS. 6A and 6B depict the time savings obtained using the system 500 to suppress transmission of state data for every second time step. FIG. 6A depicts the processing performed for two time steps without suppressing transmission of state data. Each time step therefore includes a packing and initiation step 200, data transfer step 202, and ending and unpacking step 204. Local calculations 206 are performed concurrently with the data transfer step 202 followed by performing 208 calculations of flux from neighboring elements of remote processing unit as described above. As shown in FIG. 6B, using the system 500, steps 200, 202, and 204 are suppressed for the second time step and a local predicted flux calculation 208a is instead performed. Inasmuch as the delays caused by data transmission are drastically reduced, there is greater justification to improve the performance of the kernel defining the calculations for updating each element.

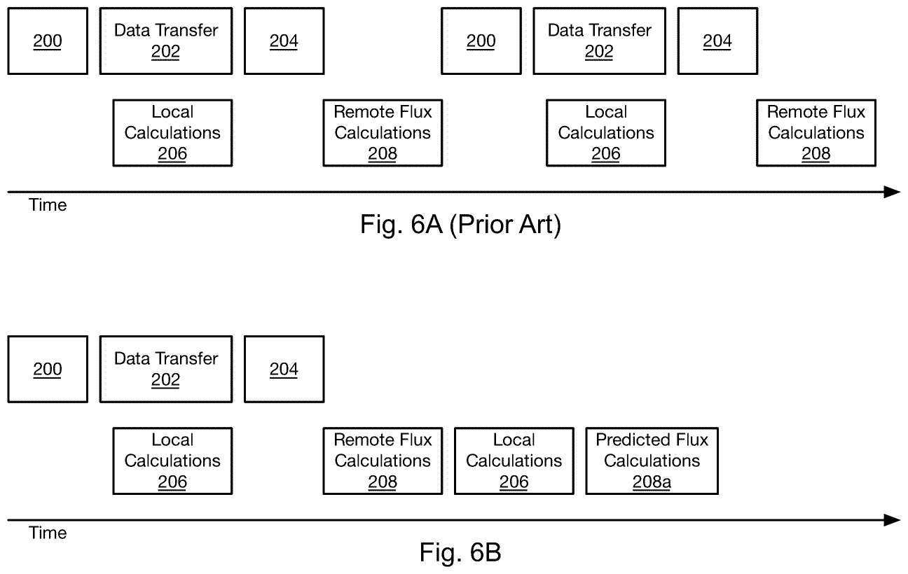

FIG. 7 is a parity graph showing predicted flux values (y axis) with respect to actual flux values (x axis) using the DNN 502 that was configured and trained as described above. The depicted plot is actually two lines that are so close as to be indistinguishable, indicating very high accuracy. The root mean square (RMS) of the parity graph was found to be 0.000043 which indicates very high accuracy.

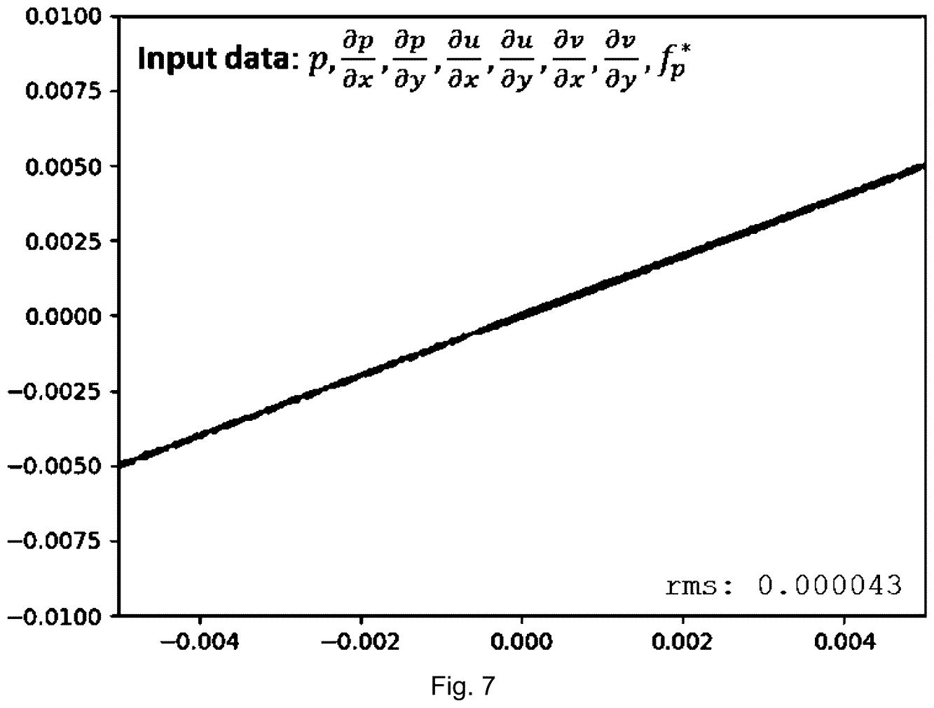

FIG. 8A is a surface plot of simulated pressure values for a model of a physical system that were obtained with transmission of flux between elements at every iteration. FIG. 8B is a surface plot of pressure values for the same model in which the flux for every element of the model (not just edge elements) was estimated using the system 500 for every other time step with the flux being calculated using data from neighboring elements for the remaining time steps. As is readily apparent, there is no visually discernible difference between the plots. Tables 2 shows the maximum and minimum values for the state variables (p, u, v) for both simulations. As is readily apparent, the system 500 was able to achieve highly accurate results. In the case of a model where the flux is only estimated using the system 500 for edge elements, the accuracy will be even greater. In Table 2, “T” indicates a simulation where transmitted flux is calculated at every time step and “S” indicates a simulation where transmitted flux is estimated using the system 500 for every other time step.

Use of the system 500 on every other time step resulted in accurate values to three or more digits of precision for all state variables. The results summarized herein were obtained using a system 500 without the normalization and denormalization stages 512, 514, respectively which, if used, would further improve accuracy.

Since transmission of flux values was suppressed at every other time step, the transmission of state data is reduced by 50 percent. Given the high degree of accuracy and numerical stability of the system 500, in some applications, the frequency of transmission of state data between partitions is reduced even more, such as once every third time step, every fourth time step, or even higher values. In some applications, transmission of state data is eliminated entirely for all time steps throughout a simulation or following a quantity of initial time steps. Where the transmission of state data is suppressed for multiple time steps, the computation of multiple time steps becomes independent and readily processed using large arrays of processing cores, such as are available in a GPU.

TABLE 2
Values of State Variables With and Without Transmission of Flux Data

| Var. | Min T | Min S | \|Difference\| | Max T | Max S | \|Difference\| |
|---|---|---|---|---|---|---|
| p | −.385806528 | −.384880002 | 9.26 × 10⁻⁴ | .357365909 | .361351670 | 3.99 × 10⁻³ |
| u | −.151311604 | −.15410946 | 2.80 × 10⁻³ | .151311604 | .151383276 | 7.16 × 10⁻⁵ |
| v | −.151311604 | −.151395664 | 8.40 × 10⁻⁵ | .151311604 | .151442548 | 1.30 × 10⁻⁴ |

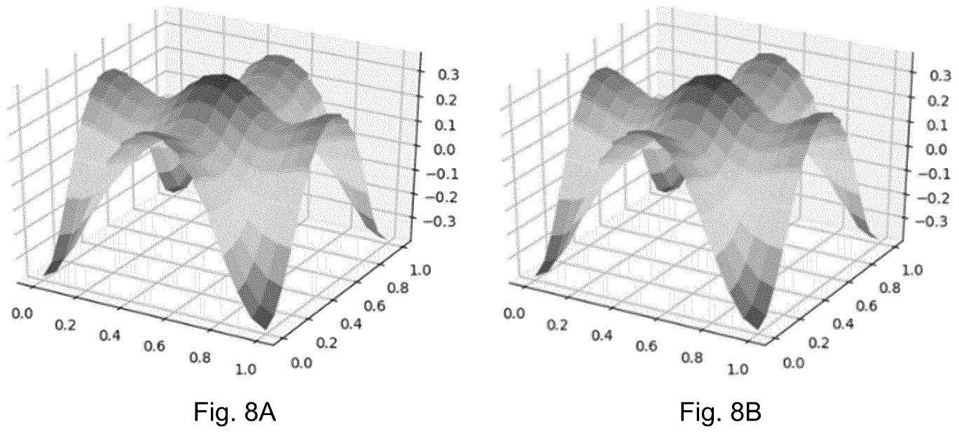

Referring to FIGS. 9A and 9B, the system 500 trained with one model of a physical system was also found to achieve a high degree of accuracy for other models of the same type of physical system. FIG. 9A represents a surface plot of pressure values obtained for a simulation using a first model configuration that is the same as that used to train the DNN 502 of the system 500. The first configuration included a first set of initial conditions, a first mesh resolution, a first polynomial degree, and first integration scheme. FIG. 9B represents a surface plot of pressure values obtained for a simulation with a second model configuration, the second model configuration including a second set of initial conditions that was different from the first set of initial conditions, a second mesh resolution that was finer than the first mesh resolution, the first polynomial degree, and a second integration scheme that was different from the first integration scheme. The simulations for both FIGS. 9A and 9B were performed with suppression of transmission of state data for every element every second time step using the system 500.

The system 500 was found to be robust and yield accurate results (see Table 3) despite the differences between the first configuration and the second configuration. The system 500 therefore was found to accurately model a type of physical system without regard to the manner in which the model of a particular physical system of that type is defined. Table 3 further shows that the error was smaller for the finer mesh despite the different configuration, which conforms to mathematical theory that there is second order convergence as the resolution of the mesh is increased.

TABLE 3
Errors Using Machine Learning for Suppression
in Different Model Configurations

| | Error with | Error with | Error with | Error with |
|---|---|---|---|---|
| | Transmission | Suppression | Transmission | Suppression |
| Variable | (1^{st} Config.) | (1^{st.} Config.) | (2^{nd} Config.) | (2^{nd} Config.) |
| p | 4.973842 × 10⁻² | 4.824839 × 10⁻² | 1.787874 × 10⁻² | 1.788846 × 10⁻² |
| u | 6.004535 × 10⁻² | 5.622781 × 10⁻² | 1.412958 × 10⁻² | 1.270965 × 10⁻² |
| v | 6.004535 × 10⁻² | 5.622851 × 10⁻² | 1.412959 × 10⁻² | 1.264351 × 10⁻² |

Table 4 summarizes additional experimental results showing the accuracy of modeling a physical system with transmission of state data being suppressed for some time steps. The experimental setup for the results of Table 4 included a unit cube made up of 13,824 elements distributed over eight processing units embodied as cores of a 24-core central processing unit (CPU). The physical system modeled was the propagation of acoustic waves and the acoustic wave equation was used. The geometry and initial conditions were sufficiently simple that an analytical solution was known. Errors for different modeling approaches could therefore be calculated by comparison to the analytical solution. Errors were calculated as the L₂ norm of pressure error after the final time step. The scenarios listed in Table 4 include a baseline (numerical modeling with transmission of state data at every time step), extrapolation every third time step, extrapolation every second time step, estimation of flux every third time step using a neural network, and estimation of flux every other time step using the neural network.

TABLE 4
Accuracy Comparison for Multiple Scenarios

| Scenario | Error vs. Analytical Solution |
|---|---|
| Baseline | 7.54 × 10⁻⁵ |
| Extrapolation (3) | 7.54 × 10⁻⁵ |
| Extrapolation (2) | NaN (unstable) |
| Neural Network (3) | 7.53 × 10⁻⁵ |
| Neural Network (2) | 7.53 × 10⁻⁵ |

As is apparent, extrapolation every third step and using the neural network for estimation every second time step and every third time step provided the same (or better) accuracy as numerical modeling with transmission of flux every time step.

Table 5 depicts the time savings obtained by modeling a physical system with transmission of state data being suppressed for some time steps. The experimental setup for the results of Table 4 included the same unit cube as for the results of Table 4 but with a finer mesh of 13,824 elements distributed over 32 nodes, each node including two 64-core server-class CPUs. The columns in Table 5 include Flux (time spent calculating flux values), Comm. (MPI communication time), and Total (the sum of these values). Times were measured for ten runs and the average values measured for these runs are listed in Table 5, along with the standard deviation (in parentheses). All values are in units of seconds.

TABLE 5
Computation Time Comparison for Multiple Scenarios

| Scenario | Flux | Comm. | Total |
|---|---|---|---|
| Baseline | 7.60 (0.85) | 91.75 (6.45) | 131.50 (6.49) |
| Extrapolation (3) | 9.40 (0.52) | 73.02 (3.35) | 116.57 (2.43) |
| Neural Network (2) | 24.80 (0.95) | 48.16 (4.82) | 107.86 (7.42) |

As shown by the results, there were a 20 percent reduction and a 48 percent reduction in communication time when extrapolation was performed every third time step and when estimation was performed every second time step using the neural network, respectively. Table 5 further shows that where the neural network was used, the time spent computing flux values increases but not enough to offset the time savings obtained by reducing communication, resulting in an overall time savings of 18 percent relative to the baseline scenario. Hardware acceleration techniques were not used to reduce the computation time when calculating flux and therefore additional time savings are achievable.

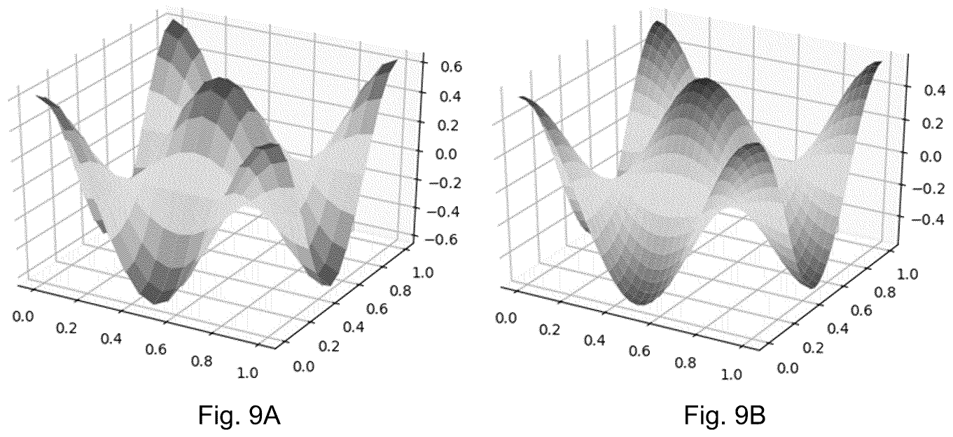

FIG. 10 depicts a system 1000 that enables both predicting flux data without performing communication of state data and determining appropriateness of predicting flux data. According to an implementation, the system 1000 includes a machine learning model such as a Bayesian neural network 1002. According to an implementation, for a current time step, the Bayesian neural network 1002 takes as inputs an element state 1004 and a prior flux value 1006. The element state 1004 includes one or more state variables of the element of the mesh. In some implementations, the element state 1004 includes first order, second order, or other derivatives of one or more of the state variables. In some implementations, the element state 1004 includes only values that are local to the local processing unit and includes only values that are inputs to the function used to compute the updated state of the element. The state variables and any derivatives thereof correspond to the physical system being modeled as described above with respect to FIG. 5. The prior flux value 1006 may be calculated from state data received by the element in the preceding time step from a neighboring element in a neighboring partition or as calculated using the Bayesian neural network 1002 in the preceding time step.

According to an implementation, the Bayesian neural network 1002 also takes as an input a prior error 1008 that is a difference between the prior flux value 1006 and a more accurate flux value. The more accurate flux value may be a flux value received from the neighboring element of the neighboring partition for the preceding time step as the prior flux value 1006 and of which the prior flux value 1006 is an estimation. During training, the more accurate flux value may be obtained from a closed form mathematical solution for the mathematical model and the values for the one or more state variables of the element state 1004 for the preceding time step and possibly the time value for the preceding time step.

According to an implementation, the output of the Bayesian neural network 1002 includes a flux estimate 1010 that approximates the flux calculated from state data received from the neighboring element of the neighboring partition for the current time step. The output of the Bayesian neural network 1002 may further include an uncertainty 1012. A Bayesian neural network 1002 outputs a value based on its current state in a probabilistic and non-deterministic manner. Accordingly, for repeated inferences for the same set of inputs, the output of the Bayesian neural network 1002 may be different. The uncertainty 1012 may therefore be a statistical characterization of a plurality of outputs of the Bayesian neural network 1002 obtained for the same state of the Bayesian neural network 1002 (i.e., no change to parameters defining the Bayesian neural network 1002) the same element state 1004 and prior flux value 1006, and possibly the prior error 1008 where used. The number of values in the plurality of outputs may be any number sufficient to estimate the uncertainty, such as at least 10 as a non-limiting example.

The statistical characterization may be a variance, standard deviation, or other characterization of variation amount the plurality of outputs, and the statistical characterization may be calculated after removing outliers. According to an implementation, the flux estimate 1010 is calculated as the median of the outputs, the mean of the outputs, or other function of the outputs. Where the flux estimate 1010 is a median or mean, outliers may be removed before calculating the median or mean. Removing outliers may include calculating a standard deviation (Sigma) and mean (M) for the plurality of outputs and removing those outputs that are more than not within M+/−X*Sigma, where X is a predefined value, such as a value greater than two.

The uncertainty 1012 may be processed using a decision algorithm 1014. The decision algorithm may evaluate the uncertainty 1012 which outputs a decision 1018 indicating whether the flux estimate 1010 should be ignored and a flux value should be obtained from the neighboring element of the neighboring partition. The decision algorithm 1014 may be a simple threshold: where the uncertainty exceeds a predefined uncertainty threshold, the decision 1018 may indicate that the flux estimate 1010 should be discarded.

Training of the Bayesian neural network 1002 for a type of a physical model (e.g., a particular set of differential equations used to model a particular type of physical system) may be performed by generating training data entries including an element state 1004 and prior flux value 1006 as inputs and, as a desired output, an accurate flux value. The accurate flux value may be obtained from either (a) a closed form mathematical solution to the physical model for the element state 1004 at a time step following the time step corresponding to the prior flux value 1006 or (b) a flux value obtained from communicated state data of a neighboring element for the time step.

Training may include processing the inputs of each training data entry using the Bayesian neural network to obtain a flux estimate, comparing the flux estimate to the accurate flux value of each training data entry according to a loss function, and updating parameters of the Bayesian neural network 1002 by a training algorithm 1016 according to the loss function. There may be many hundreds, or event millions of training data entries. During utilization, the training algorithm 1016 may continue to update parameters of the Bayesian neural network according to the prior error 1008.

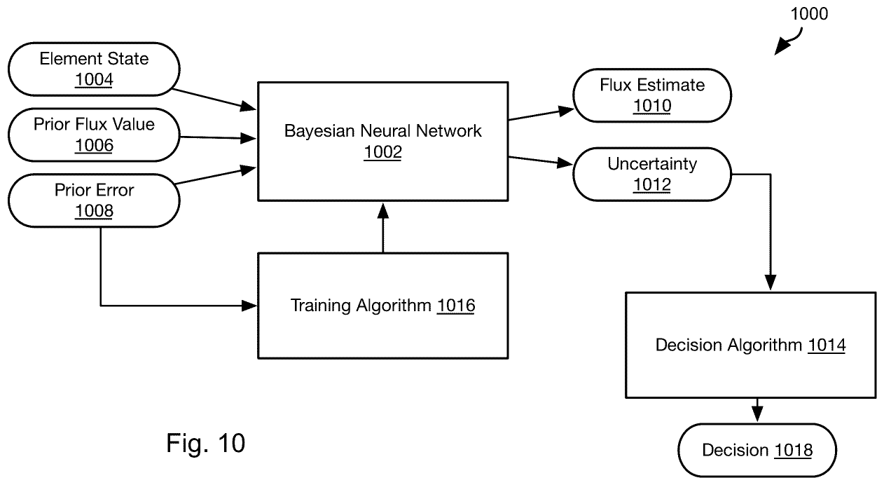

Referring to FIG. 11, according to an implementation, the depicted method 1100 is implemented using the system 1000 in order to suppress communication of state data or performing communication of state data where suppression is determined not to be appropriate. The method 1100 is performed by the local processing unit hosting the local partition with communication with the remote processing unit hosting the remote partition. The method 1100 is performed by the local processing unit with respect to any number of remote processing units and remote partitions. The method 1100 is capable of being used for a two-dimensional system, three-dimensional system, or systems modeled using a greater number of dimensions.

For some physical systems, the method 1100 is preceded by initializing state variables of elements of the model for all partitions. In particular, the state variables of one or more elements may be set to initial conditions of the physical system being modeled. The state variables of elements of the boundary of the model of the physical system are also set to boundary conditions where this is part of the physical system being modeled.

State variables are referred to in the plural in the examples discussed herein. However, a single state variable is usable without modifying the approach described herein. In some implementations, the state of an element is represented by values for the state variables as well as one or more partial derivatives of one or more of the state variables. Partial derivatives include first order and/or higher order derivatives.

The method 1100 includes in step 1102 performing local calculations. Performing local calculations includes calculating flux between non-edge elements of the local partition and updating the state variables of the non-edge elements using the flux and current values of the state variables. The manner in which the flux is calculated, and the state variables are updated, varies according to the physical system being modeled and is performed using any appropriate modeling approach.

The method 1100 includes in step 1104 evaluating whether communication of state data between the local processing unit and the remote processing unit is to be suppressed. Step 1104 may include evaluating a fixed interval: every N time steps communication may be suppressed (N being a predefined integer), every N time steps communication is performed, or a more complex pattern. Using the approach described herein, under certain conditions, communication is suppressed for many consecutive time steps until detecting conditions that are likely to lead to inaccuracy or instability. In some implementations, communication is performed for a number of initial time steps and then suppressed for all subsequent time steps unless the decision 1018 of the system 1000 indicates that communication should be performed. In such implementations, the evaluation in step 1104 may be omitted.

If communication should be skipped according to the evaluation in step 1104 (or is skipped in every instance absent a decision 1018 indicating otherwise), then in step 1108 flux values are estimated for the edge elements of the local partition. Estimating the flux values may be performed by obtaining one or more flux estimates 1010 for each edge element as described above with respect to FIG. 10. In step 1110 the decision 1018 of the system 1000 for each flux estimate 1010 is evaluated. If the decision 1018 indicates that a flux estimate 1010 for an element is to be discarded, then in step 1106 flux values are obtained from state data received from the remote processing unit for a neighboring element of the element in the remote partition. If not, then the flux estimate 1010 for the element is used.

In either case, an updated state of each edge element of the local partition is calculated in step 1112 using either the flux estimate 1010 or a received flux value for each edge element and the current state of each edge element.

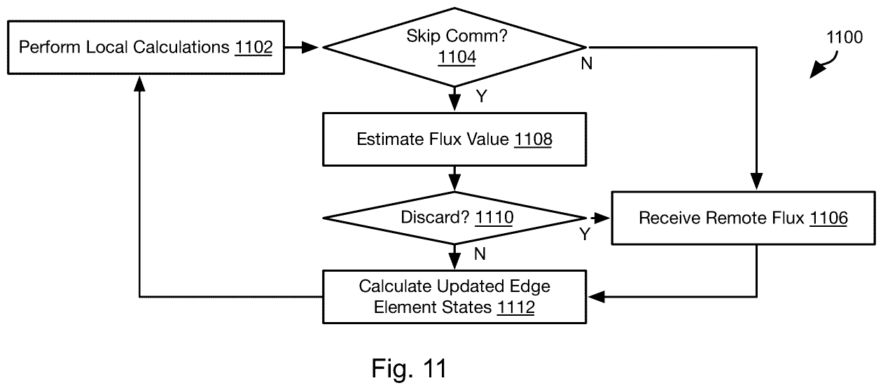

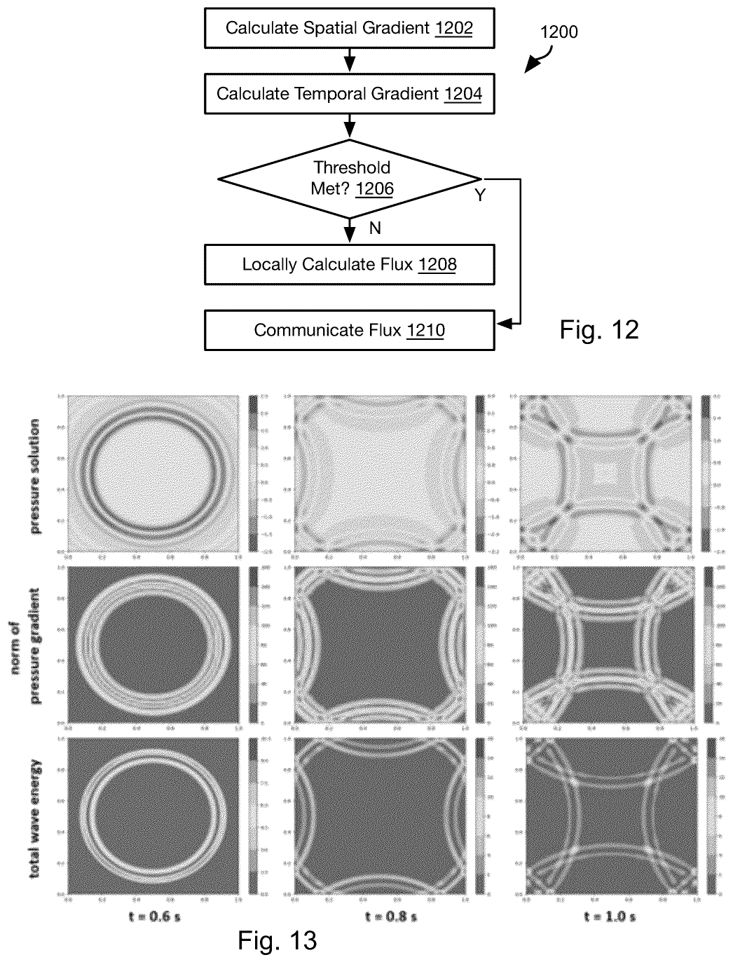

Referring to FIGS. 12 and 13, the appropriateness of suppressing communication may additionally or alternatively be determined based on complexity of the physical model at a given time step and in a local region including a given edge element.

For example, a method 1200 includes calculating in step 1202 one or more spatial gradients of the physical model with respect to one or more state variables of the physical model in one or more dimensions. For example, in the example discussed above, a spatial gradient of pressure with respect to the x, y, or z direction is calculated in step 1202. In another example, a spatial gradient velocity in the x, y, or z direction is calculated in step 1202. In yet another example, a value is derived from the one or more state variables and a spatial gradient is calculated for the derived value. For example, as shown in FIG. 13, the physical model may provide a solution for pressure (top plots). A normalized pressure gradient may be calculated for the pressure (middle plots). Alternatively, the pressure and velocity values may be used to calculate total wave energy (bottom blots). Using total wave energy has the advantage of considering both velocity and pressure such that only one gradient need be calculated or considered in order to account for complexity in both velocity and pressure. According to an implementation, the method 1200 additionally or alternatively includes calculating in step 1204 one or more temporal gradients of one or more state variables of the physical model in one or more dimensions. One or more temporal gradients (partial derivative with respect to time) may also be calculated with respect to a derivative of one or more state variables or other value derived from the one or more state variables (e.g., wave energy in the depicted example).

According to an implementation, the method 1200 includes evaluating in step 1206 the one or more gradients calculated at steps 1202 and/or 1204. The evaluation in step 1206 may include evaluating multiple gradients for the same element, such as multiple spatial gradients, multiple temporal gradients, or multiple gradients including one or more spatial gradients and one or more temporal gradients. Multiple gradients may be combined by summing, weighting and summing, or other function and the combination may then be evaluated with respect to the gradient threshold. Alternatively, each gradient may be evaluated with respect to a corresponding threshold. If any individual gradient exceeds its corresponding threshold, then the threshold condition of the evaluation in step 1206 may be deemed to be met.

If the threshold condition of the evaluation in step 1206 is found to be satisfied at a location corresponding to an element, then in step 1210 communication of state data from the neighboring element of the remote partition is performed, e.g., performed when it would otherwise be suppressed according to the method 300 or the method 1100. Otherwise, in step 1208 flux is calculated locally, e.g., performed locally when local calculation is called for according to the method 300 or the method 1100. Calculating flux locally may be performed using extrapolation (see FIG. 3), the DNN 502 (see FIG. 5), the Bayesian neural network 1002 (see FIG. 10), or other machine learning model.

Referring again to FIG. 13, as depicted in the plots, the solution for the physical model may be very uniform in some areas (areas of uniform color), which may constitute a major portion of the area being modeled. In the uniform areas, there is little to no spatial variation and extrapolation of flux values may be performed without introducing instability or significant error. In contrast, areas of non-uniform color may vary considerably with respect to location and/or time such that a flux value from a previous time step is not sufficient to estimate the flux value for a subsequent time step.

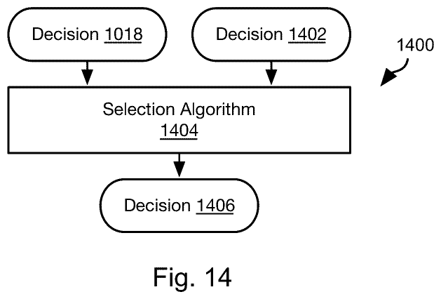

Referring to FIG. 14, in some implementations both complexity of the physical model and the uncertainty of a flux estimate is considered when determining whether or not to communicate flux values. For example, a system 1400 takes as inputs the decision 1018 and a decision 1402 that may be implemented as the result of the evaluation in step 1206. The decision 1018 and decision 1402 may be input in step 1404 to a decision algorithm to obtain a decision 1406. The decision algorithm may be implemented various ways. In a first implementation, the decision is negative (forbid local calculation of flux) if either of the decisions 1018 or 1402 is negative. In a second implementation, the decision algorithm considers underlying data. For example, the uncertainty 1012 and one or more gradients (see discussion of steps 1202 and 1204) are combined (e.g., summed, weighted and summed, multiplied by one another) and the combination compared to a combined threshold. If the combination exceeds the combined threshold, then the decision 1406 is negative. If the decision 1406 is negative then communication of flux values between partitions is performed when such communication would otherwise be suppressed according to the method 300, the method 1100, or other pattern for suppressing communication.

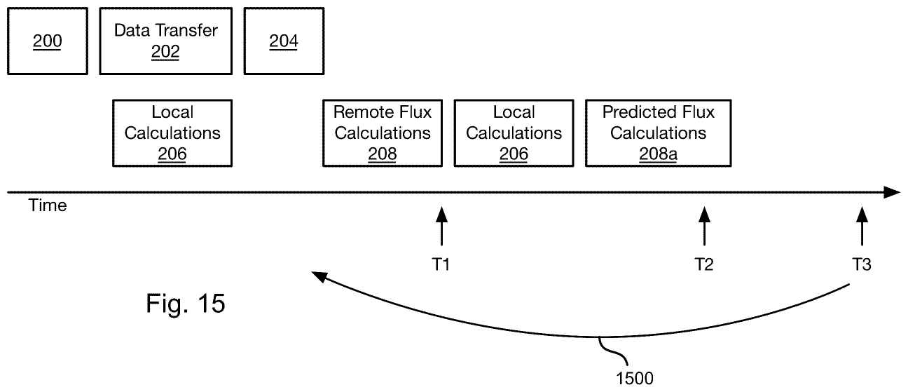

Referring to FIG. 15, the timing of evaluating the appropriateness of suppressing communication may be implemented in various ways. As used herein “evaluating the appropriateness of suppressing communication” may include evaluating the uncertainty 1012 of a flux estimate with respect to a threshold (see step 1110 of FIG. 11 and corresponding discussion), evaluating one or more gradients with respect to one or more thresholds (see step 1206 of FIG. 12 and corresponding discussion), or evaluating both (see FIG. 14 and corresponding discussion). As used herein a “positive result” of evaluating the appropriateness of suppressing communication may be understood as suppressing of communication being permitted such that flux into an element is permitted to be calculated locally. As used herein a “negative result” of evaluating the appropriateness of suppressing communication may be understood as suppressing of communication being forbidden such that flux into an element is communicated from a remote processing unit.

In a first example, evaluating the appropriateness of suppressing communication is performed at step T1 for a first time step: gradients calculated for the state of the model at the first time step and uncertainty 1012 of estimated flux calculated for the first time step. In the first example, an estimated flux value may be calculated for an element for which the communication of state data was performed in order to determine whether to suppress communication for a subsequent time step. If a negative result is obtained, then communication of state data is performed for a second time step immediately following the first time step, e.g., performed even if communication would be suppressed according to the method 300, the method 1100, or other pattern for suppressing communication. Otherwise, communication is suppressed when called for according to the method 300, the method 1100, or other pattern for suppressing communication.

In a second example, evaluating the appropriateness of suppressing communication is performed at step T2 for a time step (“the subject time step”): gradients calculated for of the state of the model the subject time step and uncertainty 1012 of estimated flux calculated for the subject time step. In the second example, the subject time step is one for which suppression of communication called for according to the method 300, the method 1100, or other pattern for suppressing communication. If a negative result is obtained, then communication of flux values is performed for the subject time step. Otherwise, communication is suppressed, and flux is calculated locally.

Note that where communication is performed, completing the calculations of the subject time step will take longer inasmuch as the determination whether to perform communication may be performed after local calculations 206 and local predicted flux calculations 208a have been performed. However, where this occurs infrequently, this delay may be acceptable.

In a third example, evaluating the appropriateness of suppressing communication is performed at step T3 that occurs after the calculations for a subject time step have completed and the state of an edge element has already been updated. In the third example, if the result is negative, the state of the model, including the state variables of the edge element, may be rolled back 1500 to the state immediately preceding the subject time step and the calculations of the subject time step are repeated without suppressing communication. To facilitate this, the state of each element for the N most recent time steps may be buffered, where N is the number of time steps to which the model may be rolled back.

The third example may enable various different scenarios. For example, the number of edge elements of a mesh that have a negative result for the subject time step may be counted. The communication required to collect this number may take longer than the time required to perform the calculations of the subject time step, which are allowed to complete in the meantime. Where the number of elements that have the negative result exceeds a threshold, the entire mesh is rolled back 1500 to its state immediately preceding the subject time step and the calculations of the first time step are repeated without suppressing communication of state data.

In another scenario for the third example, if it is determined that suppressing communication is not appropriate for an edge element for the subject time step, a flux value for the edge element is obtained using communication of state data from a remote processing unit. The flux value is compared to the flux value obtained using local computation for the edge element. If the difference between the flux value obtained using communication is within a threshold value from the flux value obtained using location calculation, then no rollback 1500 is performed. If not, then the model is rolled back 1500 to the time step immediately preceding the subject time step.

### Implementation Examples

According to one implementation, the techniques described herein are implemented by one or more special-purpose computing devices. The special-purpose computing devices in some implementations are hard-wired to perform the techniques, or include digital electronic devices such as one or more application-specific integrated circuits (ASICs) or field programmable gate arrays (FPGAs) that are persistently programmed to perform the techniques, or include one or more general purpose hardware processors programmed to perform the techniques pursuant to program instructions in firmware, memory, other storage, or a combination. In some implementations, such special-purpose computing devices also combine custom hard-wired logic, ASICs, or FPGAs with custom programming to accomplish the techniques. The special-purpose computing devices are, in some implementations, desktop computer systems, portable computer systems, handheld devices, networking devices or any other device that incorporates hard-wired and/or program logic to implement the techniques.

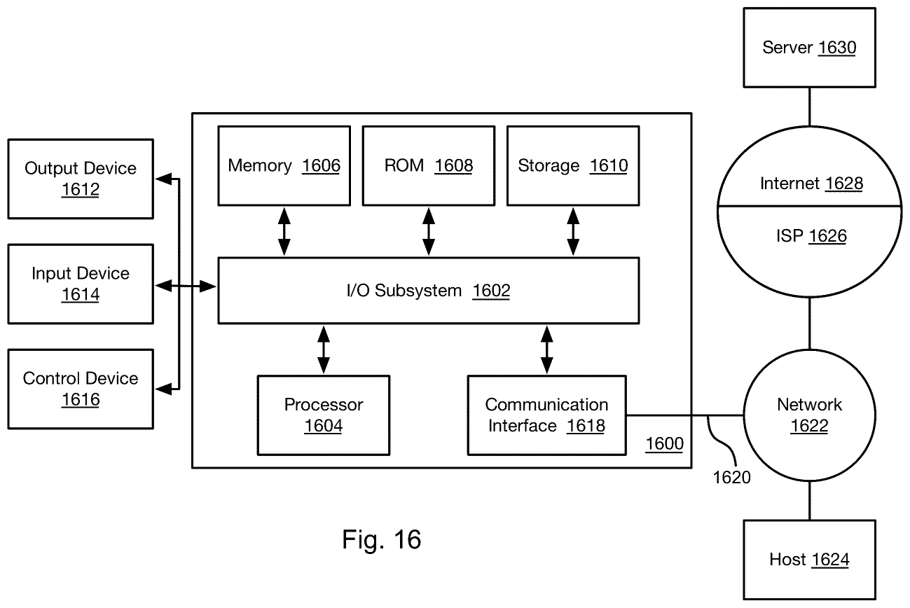

For example, FIG. 16 is a block diagram that depicts a computer system 1600 upon which an implementation is implemented in some applications. Computer system 1600 includes a bus 1602 or other communication mechanism for communicating information, and a hardware processor 1604 coupled with bus 1602 for processing information. Hardware processor 1604 is, for example, a general purpose microprocessor.

Computer system 1600 also includes a main memory 1606, such as a random access memory (RAM) or other dynamic storage device, coupled to bus 1602 for storing information and instructions to be executed by processor 1604. Main memory 1606 is used for storing temporary variables or other intermediate information during execution of instructions to be executed by processor 1604. Such instructions, when stored in non-transitory storage media accessible to processor 1604, render computer system 1600 into a special-purpose machine that is customized to perform the operations specified in the instructions.

Computer system 1600 further includes a read only memory (ROM) 1608 or other static storage device coupled to bus 1602 for storing static information and instructions for processor 1604. A storage device 1610, such as a magnetic disk, optical disk, or solid-state drive is provided and coupled to bus 1602 for storing information and instructions.

Computer system 1600, in some implementations, is coupled via bus ˜02 to a display 1612, such as a cathode ray tube (CRT), for displaying information to a computer user. An input device 1614, including alphanumeric and other keys, is coupled to bus 1602 for communicating information and command selections to processor 1604. Another type of user input device is cursor control 1616, such as a mouse, a trackball, or cursor direction keys for communicating direction information and command selections to processor 1604 and for controlling cursor movement on display 1612. This input device typically has two degrees of freedom in two axes, a first axis (e.g., x) and a second axis (e.g., y), that allows the device to specify positions in a plane.

In some applications, computer system 1600 implements the techniques described herein using customized hard-wired logic, one or more ASICs or FPGAs, firmware and/or program logic which in combination with the computer system causes or programs computer system 1600 to be a special-purpose machine. According to one implementation, the techniques herein are performed by computer system 1600 in response to processor 1604 executing one or more sequences of one or more instructions contained in main memory 1606. Such instructions are read into main memory 1606 from another storage medium, such as storage device 1610. Execution of the sequences of instructions contained in main memory 1606 causes processor 1604 to perform the process steps described herein. In alternative implementations, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, or solid-state drives, such as storage device 1610. Volatile media includes dynamic memory, such as main memory 1606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from transmission media. Transmission media participates in transferring information between storage media. For example, transmission media includes coaxial cables, copper wire and fiber optics, including the wires that comprise bus 1602. Transmission media can also take the form of acoustic or light waves, such as those generated during radio-wave and infra-red data communications.

In some applications, various forms of media are involved in carrying one or more sequences of one or more instructions to processor 1604 for execution. For example, the instructions are carried on a magnetic disk or solid-state drive of a remote computer. The remote computer can load the instructions into its dynamic memory and send the instructions over a telephone line using a modem. A modem local to computer system 1600 can receive the data on the telephone line and use an infra-red transmitter to convert the data to an infra-red signal. An infra-red detector can receive the data carried in the infra-red signal and appropriate circuitry can place the data on bus 1602. Bus 1602 carries the data to main memory 1606, from which processor 1604 retrieves and executes the instructions. The instructions received by main memory 1606 may optionally be stored on storage device 1610 either before or after execution by processor 1604.

Computer system 1600 also includes a communication interface 1618 coupled to bus 1602. Communication interface 1618 provides a two-way data communication coupling to a network link 1620 that is connected to a local network 1622. For example, communication interface 1618 is, in some implementations, an integrated services digital network (ISDN) card, cable modem, satellite modem, or a modem to provide a data communication connection to a corresponding type of telephone line. As another example, communication interface 1618 is a local area network (LAN) card to provide a data communication connection to a compatible LAN. Wireless links may also be implemented. In any such implementation, communication interface 1618 sends and receives electrical, electromagnetic or optical signals that carry digital data streams representing various types of information.

Network link 1620 typically provides data communication through one or more networks to other data devices. For example, network link 1620 provides a connection through local network 1622 to a host computer 1624 or to data equipment operated by an Internet Service Provider (ISP) 1626. ISP 1626 in turn provides data communication services through the worldwide packet data communication network now commonly referred to as the “Internet” 1628. Local network 1622 and Internet 1628 both use electrical, electromagnetic or optical signals that carry digital data streams. The signals through the various networks and the signals on network link 1620 and through communication interface 1618, which carry the digital data to and from computer system 1600, are example forms of transmission media.

Computer system 1600 can send messages and receive data, including program code, through the network(s), network link 1620 and communication interface 1618. In the Internet example, a server 1630 might transmit a requested code for an application program through Internet 1628, ISP 1626, local network 1622 and communication interface 1618.

The received code is executed by processor 1604 as it is received, and/or stored in storage device 1610, or other non-volatile storage for later execution.

In the foregoing specification, implementations have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method implemented on a computer system for executing a plurality of elements of a model of a physical system, the method comprising:
estimating a flux between a portion of the plurality of elements;
communicating state data between the portion of the plurality of elements in response to uncertainty in the model of the physical system; and
calculating the flux from state data.

2. The method of claim 1, wherein:
the plurality of elements is grouped into a plurality of partitions; and
the portion of the plurality of elements are on edges of the plurality of partitions.

3. The method of claim 1, wherein estimating the flux comprises, for each element of the portion of the plurality of elements, calculating the flux based on a previously determined flux value and a state of each element.

4. The method of claim 1, wherein locally estimating the flux comprises calculating the flux using a machine learning model.

5. The method of claim 4, wherein the machine learning model is a Bayesian neural network.

6. The method of claim 5, wherein the uncertainty in the model comprises an uncertainty in an output of the Bayesian neural network.

7. The method of claim 1, wherein the uncertainty in the model of the physical system comprises one or more gradients in the model of the physical system satisfying a threshold condition, wherein the one or more gradients include a spatial gradient, a temporal gradient, or both a spatial gradient and a temporal gradient.

8. The method of claim 1, wherein the uncertainty in the model of the physical system comprises both an uncertainty in an output of a machine learning model used for locally estimating the flux and one or more gradients in the model of the physical system satisfying a threshold condition.

9. A method comprising:
executing, on a computer system, a model of a physical system including a plurality of elements each having one or more state variables, the plurality of elements divided into a plurality of partitions; and
for each element of the plurality of elements that is on an edge of a first partition of the plurality of partitions that is adjacent a second partition of the plurality of partitions:
for each first time step of a plurality of first time steps of a plurality of time steps, communicating first state data to each element from the second partition and updating a state of each element according to the state of each element and a first flux value calculated from the state data; and
for each second time step of a plurality of second time steps of the plurality of time steps, estimating an uncertainty in the model of the physical system, determining that the uncertainty in the model of the physical system does not meet a threshold condition, and in response to determining that the uncertainty in the model of the physical system does not meet the threshold condition, estimating a second flux value for each element based on the state of each element and a preceding flux value from a preceding time step of the plurality of time steps and updating the state of each element according to the state of each element and the second flux value.

10. The method of claim 9, further comprising:
for each third time step of a plurality of third time steps of the plurality of time steps, (g) estimating an uncertainty in the model of the physical system, (h) determining that the uncertainty in the model of the physical system meets the threshold condition, (i) in response to determining that the uncertainty in the model of the physical system meets the threshold condition, communicating second state data to each element from the second partition and (j) updating the state of each element according to the state of each element and a third flux value calculated from the second state data.

11. The method of claim 9, wherein estimating the second flux value comprises estimating the second flux value using a machine learning model.

12. The method of claim 11, wherein the machine learning model is a Bayesian neural network.

13. The method of claim 12, wherein the uncertainty in the model of the physical system comprises an uncertainty in an output of the Bayesian neural network.

14. The method of claim 9, wherein the uncertainty in the model of the physical system comprises one or more gradients in the model of the physical system satisfying a threshold condition, wherein the one or more gradients include a spatial gradient, a temporal gradient, or both a spatial gradient and a temporal gradient.

15. The method of claim 9, wherein the uncertainty in the model of the physical system comprises both of an uncertainty in an output of a machine learning model used to calculate the second flux value and one or more gradients in the model of the physical system satisfying a threshold condition.

16. An apparatus comprising:
one or more processors; and
one or more memories storing instructions which, when processed by the one or more processors, cause:
estimating a flux between a portion of a plurality of elements of a model of a physical system;
communicating state data between the portion of the plurality of elements in response to uncertainty in the model of the physical system; and
calculating the flux from state data.

17. The apparatus of claim 16, wherein:
the plurality of elements is grouped into a plurality of partitions; and
the portion of the plurality of elements are on edges of the plurality of partitions.

18. The apparatus of claim 16, wherein estimating the flux comprises, for each element of the portion of the plurality of elements, calculating the flux based on a previously determined flux value and a state of each element.

19. The apparatus of claim 16, wherein locally estimating the flux for each time step of the first portion of the plurality of time steps comprises calculating the flux using a machine learning model.

20. The apparatus of claim 16, wherein the uncertainty in the model of the physical system comprises one or more of an uncertainty in an output of a machine learning model used for estimating the flux or one or more gradients in the model of the physical system satisfying a threshold condition.
